(19) United States
(12) Patent Application Publication
(10) Pub. No.: US 2026/0082156 A1
(43) Pub. Date: Mar. 19, 2026

(54) METHOD AND SYSTEM FOR INTELLIGENT CONVERSATION DETECTION IN EARPHONES

(71) Applicant: SAMSUNG ELECTRONICS CO., LTD., Suwon-si (KR)

(72) Inventors: Manas Ranjan SAHOO, Noida (IN); Pulkit Agarawal, Noida (IN)

(73) Assignee: SAMSUNG ELECTRONICS CO., LTD., Suwon-si (KR)

(21) Appl. No.: 19/217,789

(22) Filed: May 23, 2025

Related U.S. Application Data
(63) Continuation of application No. PCT/KR2025/005440, filed on Apr. 22, 2025.

(30) Foreign Application Priority Data
Sep. 13, 2024 (IN) 202411069554

(51) Int. Cl. H04R 5/04; G10L 25/30; G10L 25/78; H04R 5/033

(52) U.S. Cl. CPC H04R 5/04; G10L 25/30; G10L 25/78; H04R 5/033; G10L 2025/783; H04R 2430/01

(57) ABSTRACT

A method for conversation detection in earphones includes detecting an audio signal by at least one microphone of the earphones, wherein the detected audio signal includes a user voice; computing a relatedness score of the user voice with a playback audio of a user device; determining an intelligibility score of the user voice for a predetermined distance; determining a situation context of the user of the earphones in the detected audio signal; determining a directional probability of a conversation based on at least sensor data and the situation context; determining, using a neural network model, a conversation probability based on at least the relatedness score, the intelligibility score, the situation context, and the directional probability; adjusting a volume of the playback audio based on at least the conversation probability; and restoring the volume of the playback audio in the earphones based on determining an end of the conversation.

### CROSS-REFERENCE TO RELATED APPLICATIONS

This application is a bypass continuation application of International Application No. PCT/KR2025/005440, filed on Apr. 22, 2025, which claims priority to Indian Patent Application number 202411069554, filed on Sep. 13, 2024, in the Intellectual Property India, the disclosures of which are incorporated by reference herein in their entireties.

### BACKGROUND

### 1. Field

The present disclosure generally relates to field of audio devices. More particularly, the present disclosure relates to method and system for conversation detection in earphones.

### 2. Related Art

Wireless headphones and earbuds have become essential accessories for smartphone users, enabling them to watch movies, and shows, and listen to music and audiobooks with ease. These wireless devices have gained popularity due to features such as noise cancellation, ambient sound mode, and conversation awareness, which enhance the overall media consumption experience.

Original Equipment Manufacturers (OEMs) have focused on developing earbuds that align with daily human behaviours, leading to the introduction of the Conversation Awareness feature. This feature allows users to remain aware of their surroundings while wearing earbuds, which is particularly useful during conversations while listening to music. When speech is detected, the media volume is automatically lowered, and nearby voices are amplified. Once the conversation ends, the media volume is restored, and the noise-control settings revert to their previous state.

Despite the benefits of the conversation awareness feature, several challenges remain. For example, one challenge is that the feature lowers media volume when any speech is detected, enabling users to converse while experiencing virtual Dolby atmosphere at a lower volume. However, this feature may mistakenly reduce the media volume even when no conversation is occurring, or this feature may fail to detect speech during an actual conversation. This inconsistency diminishes the efficacy of the feature in enhancing user experience.

In the related art, the conversation awareness feature gets activated only when the user speaks. This limitation causes inconvenience when others try to address the user, as the user may not notice them due to the blocked ears and media playback in the earphones. As a result, users often have to ask others to repeat themselves to activate conversation awareness, hindering the spontaneity of conversations. Although this issue may seem minor, this issue raises concerns about the feature's effectiveness in facilitating natural and spontaneous interactions.

Moreover, in noisy environments such as school buses, public areas, malls, restaurants, and crowded spaces, the conversation awareness feature may fail to capture the voice of the person speaking to the user. In such situations, the earbud volume may abruptly return to its original level, leaving the user unable to hear anything, which further illustrates the limitations of the conversation awareness feature in complex acoustic environments.

Additionally, while wearing earbuds and enjoying music, users may engage in activities such as singing, humming, or lip-syncing, which can unintentionally activate the conversation awareness feature. This feature may mistakenly interpret these actions as an intention to speak, causing the media volume to drop and disrupting the music flow. This unintended activation leads to users missing the rhythm and stopping their humming or murmuring when they realize the volume drop, ultimately disrupting their enjoyment of a seamless listening experience.

Therefore, while the conversation awareness feature in the related art offers notable benefits, it faces challenges related to limited activation, difficulty in noisy environments, and unintended activation during user activities like singing or humming, all of which affect the overall user experience. Therefore, there is a need for a method and system that enhances the conversation awareness feature in earphones by ensuring accurate activation in various environments and preventing unintended activation during user activities, thereby improving the overall user experience.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to an aspect of the disclosure, a method for conversation detection in earphones includes: detecting an audio signal by at least one microphone of the earphones, wherein the detected audio signal includes a user voice of a user of the earphones; determining a relatedness score of the user voice with a playback audio of a user device; determining an intelligibility score of the user voice for a predetermined distance; determining a situation context of the user of the earphones in the detected audio signal, wherein the situation context includes at least one of an ambient noise level, an activity state of the user of the earphones, one or more unique voices different from the user voice, a location of the user of the earphones, and a time of day; determining a directional probability of a conversation based on at least sensor data and the situation context; determining, using a neural network model, a conversation probability based on at least the relatedness score, the intelligibility score, the situation context, and the directional probability, the conversation probability indicating a probability that the conversation has started; adjusting a volume of the playback audio based on at least the conversation probability; and restoring the volume of the playback audio in the earphones based on determining an end of the conversation.

According to an aspect of the disclosure, a system for conversation detection in earphones includes: a memory storing one or more instructions; one or more sensors; a neural network model; at least one processor operatively coupled to the memory, the one or more sensors, and the neural network model, wherein the one or more instructions, when executed by the at least one processor individually or collectively, cause the system to: detect an audio signal by at least one microphone of the earphones, wherein the detected audio signal includes a user voice of a user of the earphones, determine a relatedness score of the user voice with a playback audio of a user device, determine an intelligibility score of the user voice for a predetermined distance, determine a situation context of the user of the earphones in the detected audio signal, wherein the situation context includes at least one of an ambient noise level, an activity state of the user of the earphones, one or more unique voices different from the user voice, a location of the user of the earphones, and a time of day, compute a directional probability of a conversation based on at least sensor data and the situation context, determine, using the neural network model, a conversation probability based on at least the relatedness score, the intelligibility score, the situation context, and the directional probability, the conversation probability indicating a probability that the conversation has started, adjust a volume of the playback audio based on at least the conversation probability, and restore the volume of the playback audio in the earphones based on determination of an end of the conversation.

According to an aspect of the disclosure, a non-transitory computer readable medium having instructions stored therein, which when executed by a processor cause the processor to execute a method for conversation detection in earphones includes: detecting an audio signal by at least one microphone of the earphones, wherein the detected audio signal includes a user voice of a user of the earphones; determining a relatedness score of the user voice with a playback audio of a user device; determining an intelligibility score of the user voice for a predetermined distance; determining a situation context of the user of the earphones in the detected audio signal, wherein the situation context includes at least one of an ambient noise level, activity state of the user of the earphones, one or more unique voices different from the user voice, a location of the user of the earphones, and a time of day; determining a directional probability of a conversation based on at least sensor data and the situation context; determining, using a neural network model, a conversation probability based on at least the relatedness score, the intelligibility score, the situation context, and the directional probability, the conversation probability indicating a probability that the conversation has started; adjusting a volume of the playback audio based on at least the conversation probability; and restoring the volume of the playback audio in the earphones based on determining an end of the conversation.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates an environment for conversation detection in earphones, in accordance with some embodiments of the present disclosure;

FIG. 2A illustrates an example of relatedness score computation, in accordance with one or more embodiments of the present disclosure;

FIG. 2B illustrates an example of intelligibility score determination, in accordance with an embodiment of the present disclosure;

FIG. 2C illustrates an example of situation context determination, in accordance with an embodiment of the present disclosure;

FIG. 2D illustrates an example of a conversation detection in earphones, in accordance with an embodiment of the present disclosure;

FIG. 3A illustrates a block diagram for identifying the one or more unique voices in the audio samples, in accordance with some embodiments of the present disclosure;

FIG. 3B illustrates a block diagram for determining direction of one or more unique voices identified in the audio sample, in accordance with some embodiments of the present disclosure;

FIG. 4 illustrates a block diagram for training a neural network model to determine the probability of a conversation, in accordance with an embodiment of the present disclosure;

FIG. 5 illustrates a block diagram of a system for conversation detection in earphones, in accordance with an embodiment of the present disclosure; and

FIG. 6 illustrates a flowchart for a method for conversation detection in earphones, in accordance with an embodiment of the present disclosure.

It may be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It can be understood, however that it is not intended to limit the disclosure to the particular forms disclosed, but on the contrary, the disclosure is to cover a plurality of modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part thereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The terminology “Artificial intelligence (AI) model” and “neural network” are interchangeably used throughout the specification. The AI module may be a combination of hardware module and software module. The hardware module may comprise necessary circuitry to perform the functionality discussed in the embodiments below.

Embodiments of the present disclosure, relate to a method and system for conversation detection in earphones. According to an embodiment of the present disclosure, the method and system provides conversation probability detection by recognizing the conversation based on user speech, playback audio, head direction & environmental factors. Accordingly, the system adjusts the playback audio volume by monitoring conversation continuity based on head and voice dynamics. The system computes the relatedness score of the user's voice with respect to the playback audio in order to ensure that the volume of the playback audio is not reduced if the user is singing or humming the song of the playback audio. Further, in order to detect the probability of a conversation, the system computes the intelligibility score of the user's voice. The system also computes the directional probability of conversation by tracking the head direction. The system also measures the environmental context such as ambient noise, location, time of day, and number of nearby speakers to classify the probability of conversation using a neural network model. Therefore, the method and system of the present disclosure enhances the conversation awareness feature in earphones by ensuring accurate activation in various environments and preventing unintended activation during user activities like humming or singing, thereby improving the overall user experience.

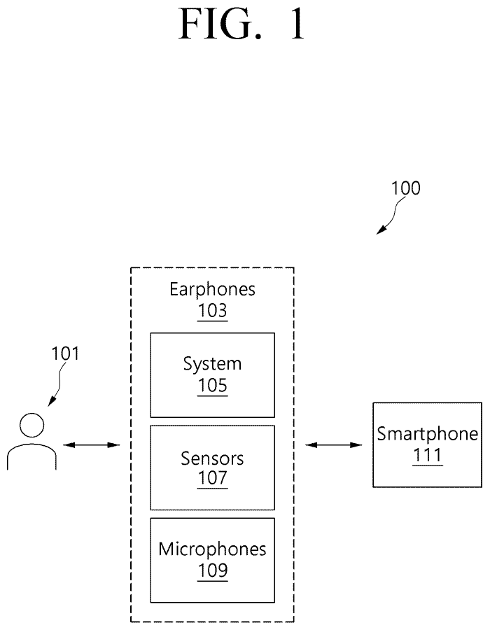

FIG. 1 illustrates an environment 100 for conversation detection in earphones, in accordance with some embodiments of the present disclosure. The environment 100 may include a pair of earphones 103 worn by a user 101, and a smartphone or smartphone 111 in communication with the pair of earphones 103. The pair of earphones 103 may include a system 105 for conversation detection, one or more sensors 107, and one or more microphones 109. In one or more embodiments, the earphones 103 may connect with the smartphone 111 via a wireless connection (e.g., Bluetooth). In one or more embodiments, the earphones 103 may connect with the smartphone 111 via wired connection.

The one or more sensors 107 may at least comprise an accelerometer and a gyroscope. The one or more sensors 107 may be configured to capture inertial measurement unit (IMU) data. The IMU data comprises of an angular velocity and linear acceleration corresponding to the user movement. The one or more microphones 109 may be configured to capture audio signals. The audio signals may comprise the user voice along with ambient noise signals from the environment surrounding the user 101. In an embodiment, the audio signals may also comprise voice signals of other speakers present at a predetermined distance from the user 101. The earphones 103 may also be configured to play an audio of the user's choice which the user 101 may select on the smartphone 111 connected to the pair of earphones 103. In one or more examples, each speaker other than the user of the earphone 103 may be at a different distance to the user of the earphone 103

In one non-limiting embodiment, the smartphone 111 may comprise one or more sensors including an accelerometer and gyroscope, which may be configured to capture inertial measurement unit (IMU) data. The IMU data may comprise of angular velocity and linear acceleration corresponding to the user movement. The smartphone 111 may also be configured to provide the location of the user 101, date and time of day, and the user movement as input to the system 105.

The system 105 may be configured to take the audio signals from the one or more microphones 109, sensor data from the more or more sensors 107 as input. The system may also be configured to receive the sensor data from the one or more sensors of the smartphone 111 as well as date and time of day as input from the smartphone 111. The system may be configured to use the one or more inputs from the pair of earphones 103 and the smartphone 111 for conversation detection. The conversation detection is discussed in further detail in the below embodiments.

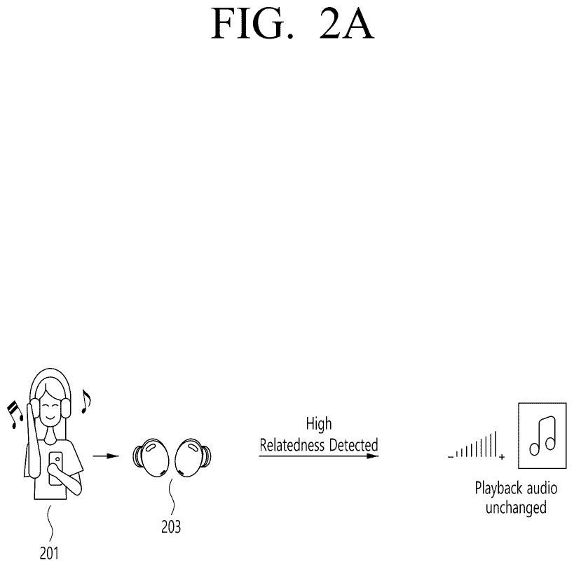

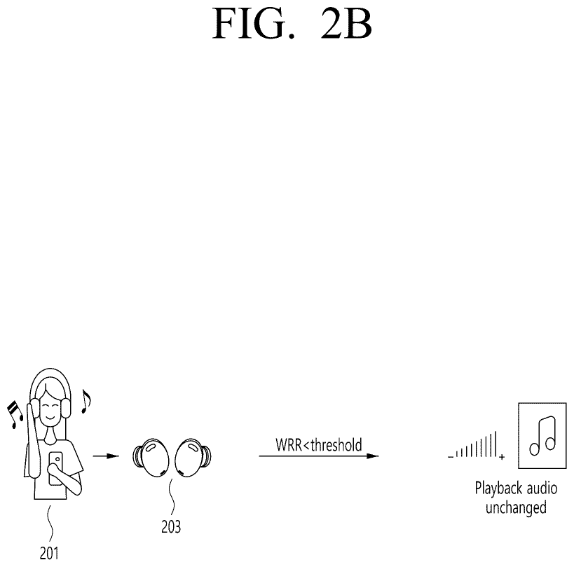

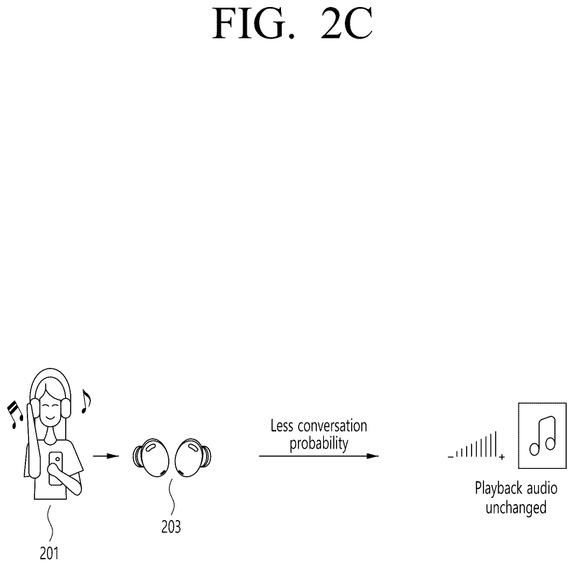

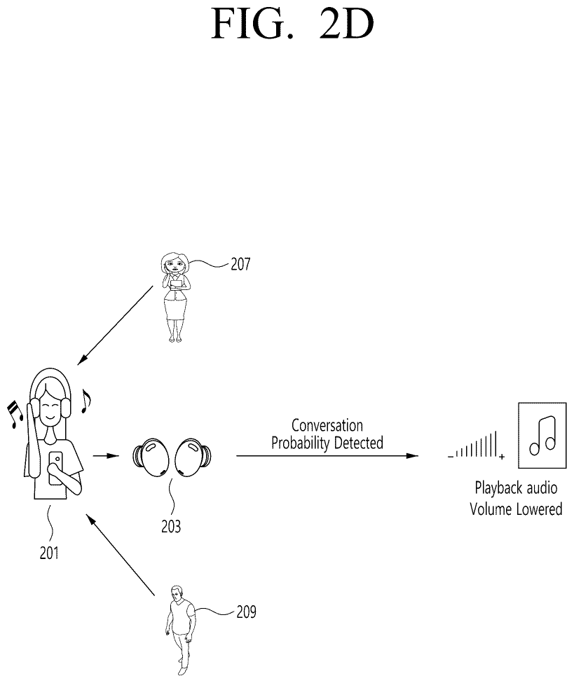

FIG. 2A illustrates an example of relatedness score computation, in accordance with an embodiment of the present disclosure.

As shown in FIG. 2A, a user 201 may be using a pair of earphones 203 to listen to an audio of the user's choice selected on a user device. The pair of earphones 203 may be similar to earphones 103 and the pair of earphones 203 may comprise the system 105. In one or more examples, a user may be listening to an audio which may be a song or podcast comprising of words. The user may be singing or humming the song playing in the earphones 203. The microphones of the earphones 203 may capture the audio signal. The system 105 for conversation detection which is a part of the earphones 203 may detect the audio signal and may determine that the audio signal comprises of the user's voice. In an embodiment, the system 105 may be pre-trained using the user's voice to accurately identify the user's voice from an audio signal. For example, before the user uses the earphones 203, the user's smartphone may perform a training process where the user inputs one or more voice samples into a speech recognition application.

Upon detecting the audio signal with the user's voice, the system 105 may compute the relatedness score of the user voice with the playback audio playing in the earphones 203. For this purpose, the system 105 may extract a portion of the playback audio corresponding to a predetermined time duration prior to and after a timestamp at which user's voice is detected. The above portion of the playback audio is extracted as the user may be humming previous, present, or upcoming words of the playback audio.

Thereafter, the system 105 may compute feature vectors for each frame of the portion of the playback audio and the user voice. Thereafter, the system 105 may measure a cosine similarity between the feature vectors of the portion of the playback audio and the feature vectors of the user voice. In the case where the user is humming or singing the same song as the playback audio, the cosine similarity between the feature vectors of the playback audio and the feature vectors of the user's voice will be high. Thereafter, the system 105 may calculate the relatedness score based on the measured cosine similarity. In one or more examples, one or more words from the playback audio may be extracted, where it is determined the user is singing the same song as the playback audio if the user is singing one or more words that matches the playback of the audio. In one or more examples, a tune from the audio may be extracted, where it is determined the user is singing the same song as the playback audio if the user is humming a tune that matches the playback of the audio.

In the present example, since the user 201 is humming the same song as the playback audio, the relatedness score will be high. Therefore, the volume of the playback audio will not be adjusted as no conversation would be detected. Therefore, the user 201 may continue to listen to the audio at the same volume at which the audio is playing while humming or singing the song.

FIG. 2B illustrates an example of intelligibility score determination, in accordance with an embodiment of the present disclosure;

As shown in FIG. 2B, a user 201 may be using a pair of earphones 203 to listen to an audio of the user's choice selected on a user device. In an example, a user may be listening to an audio which may be a song comprising of words. The user may be singing or humming the song playing in the earphones 203. The user 201 may be humming or singing the same song as the playback audio in a noisy environment. The microphones of the earphones 203 may capture the audio signal. The system 105 for conversation detection which is a part of the earphones 203 may detect the audio signal and may determine that the audio signal comprises the user's voice. In an embodiment, the system 105 may be pre-trained using the user's voice to accurately identify the user's voice from an audio signal.

Upon detecting the audio signal with the user's voice, the system 105 may determine the intelligibility score of the user voice for a predetermined distance. For this purpose, the system 105 may add attenuation to the user voice for the predetermined distance. The amount of attenuation added to the user voice may be based on the predetermined distance. The predetermined distance may be normal conversation distance. Thereafter, the system 105 may generate a modified voice signal by adding an ambient noise signal to the attenuated user voice. In one or more examples, the ambient noise signal comprises an environmental noise present in the surrounding of the user 201. In one or more examples, the ambient noise signal may be a predetermined noise signal such as white noise or any other suitable noise outputted at a predetermined frequency.

Then, the system 105 may perform an audio speech recognition on the user voice and the modified voice signal. The system 105 may determine a word recognition rate of the modified voice signal based on the user voice and the modified signal. The system 105 may compute the intelligibility score based on the word recognition rate. In a case where the word recognition rate is equal to higher than the pre-determined threshold, the system 105 computes the intelligibility score to have a high value. On the other hand, if the word recognition rate is low, the system 105 computes a low intelligibility score. In the case where the intelligibility score is low, the system 105 determines that no conversation is detected.

In the present example, since the user 201 is humming or singing the playback audio in a very noisy environment and in a low voice, the intelligibility score of the user voice will be low and therefore the system 105 will not detect any conversation. The volume of the playback audio will not be adjusted as no conversation would be detected. Therefore, the user 201 may continue to listen to the audio at the same volume at which the audio is playing before the user started humming or singing the song.

FIG. 2C illustrates an example of situation context determination, in accordance with an embodiment of the present disclosure.

As shown in FIG. 2C, a user 201 may be using a pair of earphones 203 to listen to an audio of the user's choice selected on a user device. In an example, a user may be listening to an audio in the earphones 203 and the audio may be a song comprising of words. The user may be singing or humming the song playing in the earphones 203. The user 201 may be running in a park at night. The microphones of the earphones 203 may capture the audio signal. The system 105 for conversation detection which is a part of the earphones 203 may detect the audio signal and may determine that the audio signal comprises of the user's voice. In an embodiment, the system 105 may be pre-trained using the user's voice to accurately identify the user's voice from an audio signal.

Upon detecting the audio signal with the user's voice, the system 105 may determine a situation context of the user 201. In one or more examples, the situation context of the user 201 comprises at least one of ambient noise level, activity state of the user, nearby unique voices, a location of the user, and a time of day.

In order to determine the ambient noise level, the system 105 may determine the decibel level of the user voice. The system 105 may determine the decibel level of the ambient noise signal. The system 105 may determine the ambient noise level based on the decibel level of the user voice and the decibel level of the ambient noise signal.

In an embodiment, the system 105 may determine a high ambient noise level in the case where the decibel level of the ambient noise signal is higher than the user voice signal. On the other hand, the system 105 may determine a low ambient noise level in the case where the decibel level of the ambient noise signal is lower than the user voice signal. In the present example, since the user 201 is running in a park at night, the ambient noise level may be low.

Further, to determine the situation context of the user 201, the system 105 may also determine the activity state of the user 201. An activity state of a user indicates the act being performed by the user 201 which may include sitting, standing, walking, running, climbing stairs, etc. The system 105 may determine the activity state of the user based on the sensor data captured by one or more sensors. The one or more sensors may comprise an accelerator and a gyroscope. However, the one or more sensors are not limited to above example and any other sensors that may be used for determining user activity and known to a person skilled in the art is well with the scope of the present disclosure.

In an embodiment, the one or more sensors may be installed in the earphones 203. In another embodiment, the system 105 may receive the sensor data from the one or more sensors installed on the smartphone and connected to the system 105 of the earphones 203. In the present example, the system 105 may determine the user activity state as running based on the sensor data received from the accelerator and gyroscope.

Furthermore, to determine the situation context of the user 201, the system 105 may also determine the nearby unique voices. In an embodiment, the nearby unique voices may be the voices of one or more persons present in the user 201 environment and capable of having a potential conversation with the user 201.

In order to determine one or more unique voices, the system 105 may retrieve one or more audio samples of a predetermined time period from the detected audio signal comprising the user voice. Thereafter, the system 105 may apply speech diarization technique on the one or more audio samples to identify one or more unique voices in the audio samples. The method of determining one or more unique voices is discussed in detail in the embodiments below.

In the present example, the system 105 may not detect any unique voices near the user 201. Further, the system 105 may receive a location of the user, and a time of day from the smartphone connected to the system 105 and the earphones 203. In the present example, the system 105 will receive the time-of-day night from the smartphone.

Therefore, the system 105 may determine that no conversation is taking place based on the situation context. Accordingly, the volume of the playback audio will not be adjusted as no conversation would be detected. Therefore, the user 201 may continue to listen to the audio at the same volume.

FIG. 2D illustrates an example of a conversation detection in earphones, in accordance with an embodiment of the present disclosure.

As shown in FIG. 2D, a user 201 may be using a pair of earphones 203 to listen to an audio of the user's choice selected on a user device. In an example, a user may be listening to an audio in the earphones 203 while working at their desk in office. The user may have two colleagues, colleague A 207 and colleague B 209 on the left and right side of the user 201 respectively. The user 201 may start having a conversation with colleague A 207 such that the user 201 may turn their head to the left side and start speaking with colleague A 207. Colleague B 209 may also be talking to somebody else on the phone but may not be having a conversation with the user 201. When the user 201 starts speaking with colleague A 207, the microphones of the earphones 203 may capture the audio signal. The system 105 for conversation detection may detect the audio signal and may determine that the audio signal comprises the user's voice. In an embodiment, the system 105 may be pre-trained using the user's voice to accurately identify the user's voice from an audio signal.

In an embodiment, the system 105 may compute the relatedness score of the user voice with a playback audio of a user device as discussed in the above embodiments. In the present example, since the user 201 is having a conversation with the colleague A 207, the relatedness score will be low. Thereafter, the system 105 may determine the intelligibility score of the user voice for a predetermined distance as discussed in the above embodiments. In the present example, the user voice will have a high intelligibility score since the user is conversing with colleague A 207 who is at an approximate distance of one meter from the user 201.

Thereafter, the system 105 may determine the situation context of the user as discussed in the above embodiments. The system 105 may determine that the ambient noise level is high (e.g., ambient noise is above a predetermined threshold) thereby indicating that the environment of the user may not be silent. Moreover, based on the sensor data, the system 105 may determine that the user is sitting. The system 105 may also receive information related to time of day and location of user and determine that it is probable that the user 201 may be in an environment where the user 201 may be surrounded by other persons.

Thereafter, the system 105 may determine the unique voices surrounding the user as discussed in the above embodiments. The system 105 may determine that the audio signal comprises one two unique voices.

The system 105 may determine the direction of one or more unique voices identified in the audio samples. For this purpose, the system 105 may identify a difference in timestamps of a voice of a same speaker in a microphone of a left earphone and in a microphone of a right earphone for each unique voice. Thereafter, the system 105 may identify a difference in decibel levels of voice of same speaker in the microphone of the left earphone and in the microphone of the right earphone; and determine whether a position of the speaker of each unique voice is on a right side or a left side of the user based on at least the difference in the timestamps and difference in decibel levels. In the present example, the system may determine that the unique voice of colleague A 207 is to the left of the user and the unique voice of colleague B is to the right of the user.

Further, the system 105 may compute a directional probability of conversation. The system 105 may receive inertial measurement unit (IMU) data captured by one or more sensors. In one embodiment, the one or more sensors may be installed in the earphones 203 and may provide the captured IMU data to the system 105. Further, the system 105 may filter noise from the IMU data by applying high/low pass filter to the IMU data. The system 105 may then determine head tracking information by applying a sensor fusion technique to the filtered IMU data. Further, the system 105 may determine a direction of the user's head based on the head tracking information. In the present example, the tracking information received from the one or more sensors will indicate that the user has turned the head to the left side.

The system 105 may be then configured to match the direction of the user's head with the direction of each unique voice to determine the directional probability of conversation. In the present example, based on the IMU data received from the one or more sensors, the system 105 may determine that the user 201 has turned the head to the left side in the direction of colleague A's unique voice and therefore, the directional probability of conversation may be to the left side of the user 201.

Lastly, the system 105 may determine a conversational probability. The system 105 may comprise a neural network model which may be configured to receive the relatedness score, the intelligibility score, the situation context, and the directional probability as input for processing. In one or more examples, the neural network model may provide a conversation probability based on the relatedness score and the intelligibility score.

In another embodiment, the neural network model may be configured to provide a conversation probability based on the intelligibility score, the situation context and the directional probability of conversation. In the present case, the neural network may provide a probability of conversation with colleague A 207 based on the low relatedness score, the high intelligibility score, as well as the situation context and the directional probability of conversation being to the left side of the user.

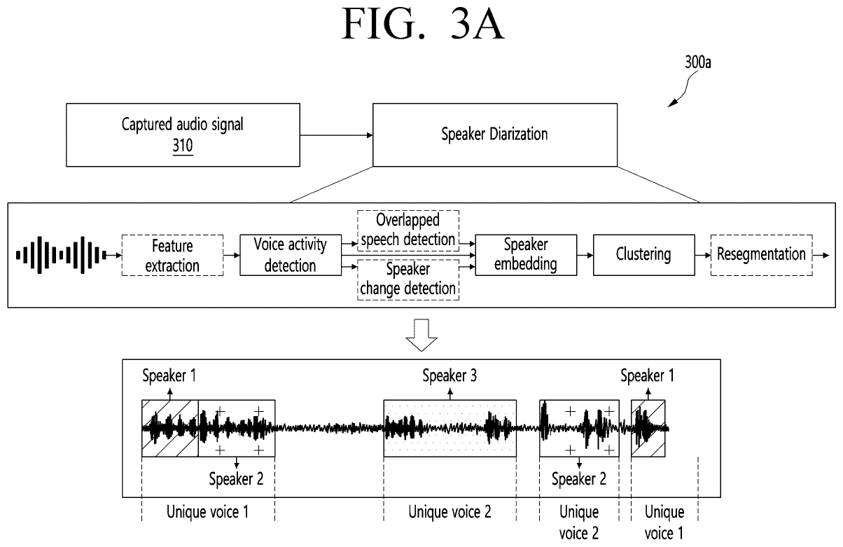

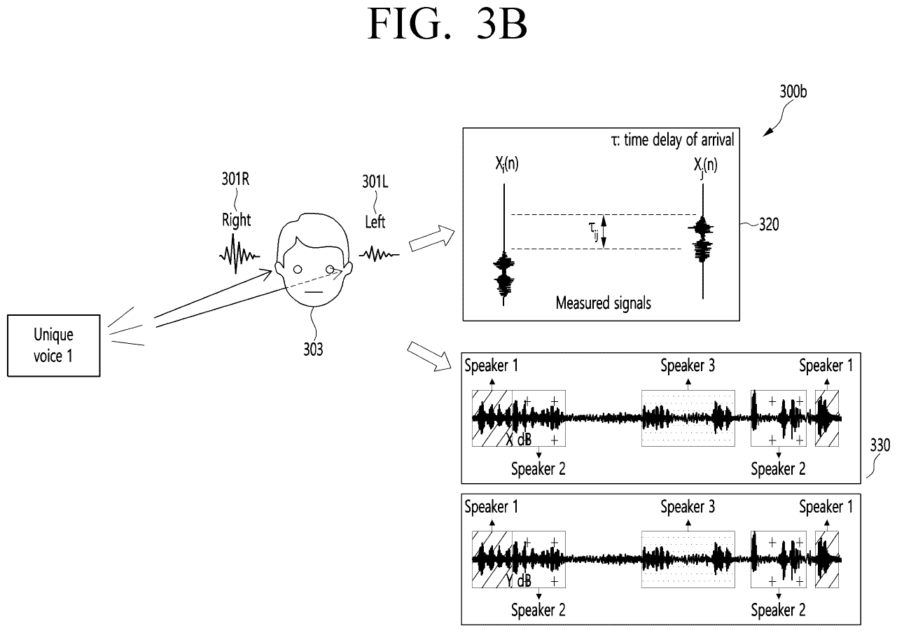

FIG. 3A illustrates a block diagram 300a for identifying the one or more unique voices in the audio samples, in accordance with some embodiments of the present disclosure.

As shown in FIG. 3A, the captured audio signal 310 of a predetermined time period may be retrieved by the system 105. The captured audio signal 310 may comprise of one or more unique voices and the one or more unique voices are voices of persons other than the user.

The system 105 may be configured to perform speech diarization on the captured audio signal 310, to determine the one or more unique voices and the timestamps of the one or more unique voices. In one or more examples, speech diarization may include the process of partitioning an audio stream containing human speech into homogeneous segments according to an identity of each speaker. The speech diarization may include feature extraction in which features of the audio signals are detected. Then, on the extracted features voice activity detection is performed. The speech diarization may further include overlapped speech detection and speaker change detection. Then, speaker embedding is performed to understand the number of speakers in the audio signal. The speech diarization may finally include clustering and re-segmentation of the unique speaker voices.

As shown in the FIG. 3A, the system 105 may determine that the captured audio signal 301 has two unique voices 1 and 2. However, embodiments of the present disclosure are not limited to above mentioned voice detection technique, and embodiments may implement any other suitable technique known to one of ordinary skill in the art that may be used for determining one or more unique voices in an audio signal.

FIG. 3B illustrates a block diagram 300b for determining direction of one or more unique voices identified in the audio sample, in accordance with some embodiments of the present disclosure.

One or more audio samples containing the unique voices are captured by the right and left microphones of the earphones. After the unique voices have been determined as discussed in the above embodiments, the system 105 may be configured to determine the direction of the one or more unique voices.

As shown in FIG. 3B audio samples 301L and 301R comprising the unique voice 1 are captured by the left and right microphones of the earphones respectively. Thereafter, the system 105 may be configured to determine the difference in the timestamps of the left audio sample 301L and the right audio sample 301R, as indicated in voice sample graph 320. Further, the system 105 may also determine the difference in the decibel levels of the left audio sample 301L and the right audio sample 301R as indicated in voice sample graph 330.

The system 105 may determine the position of the unique voice with respect to the speaker based on the difference in the timestamps and difference in decibel levels. In the case where the unique voice is on the left side of the user, the timestamp of the left audio sample 301L will be earlier than the right audio sample 301R. Further, the decibel level of the left audio sample 301L will be higher than the right audio sample 301R. On the other hand, in the case where the unique voice is on the right side of the user, the timestamp of the left audio sample 301L will be later than the right audio sample 301R. Further, the decibel level of the left audio sample 301L will be less than the right audio sample 301R.

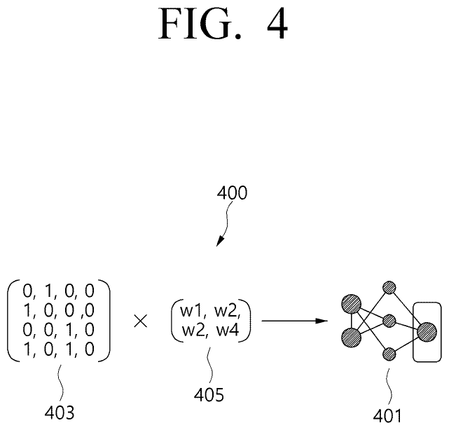

FIG. 4 illustrates a block diagram 400 for training a neural network model to determine the probability of a conversation, in accordance with an embodiment of the present disclosure. In one or more examples, the neural network model may be trained remotely and downloaded to a user's device (e.g., smartphone 111). In one or more examples, the neural network model may be trained on the user's device. In one or more example, the neural network model may be periodically updated.

The system 105 may comprise the neural network model 401 which may receive the relatedness score, the intelligibility score, the situation context, and the directional probability as input for processing. The neural network model 401 may be trained to determine the probability of conversation based on a sample set of parameters including relatedness scores, intelligibility scores, situation context, and directional probability for estimating of the conversation probability as shown in FIG. 4. A set of sample input vectors 403 representing the sample set of parameters and an initial weight input matrix 405 are provided as input to the neural network model 401. Further, each parameter may be assigned a corresponding weight, and the weights are adjusted during training such that the neural network model 401, During the inference stage, the neural network model 401 may provide a predicted regression value that represents the probability of conversation.

Table 1 below provides an example of conversation probability for varied values received as input by the neural network model 401.

TABLE 1

| Input Features | Model Input Data |
|---|---|
| (A) Relatedness score | A value between 0-1 representing the |
| | relatedness of user utterance w.r.t |
| | playback audio |
| (B) Directional Probability | A binary value either 1 or 0 representing |
| | whether user utterance is in the direction |
| | of potential listeners |
| (C) Ambient Noise Level | A value ranging from few dBs (~20 dB- |
| | 150 dB) |
| (D) Intelligibility Score | A value between 0-1 representing the word |
| | recognition rate of ASR |
| (E) Location Category | An encoded representation of location |
| | category like Home - 0, Work - 1, Outdoor - |
| | 2 etc. |
| (F) Number of Unique | A decimal value representing the count of |
| Speakers nearby | unique listeners nearby in past N minutes |
| (G) Time of day Category | An encoded representation of time category |
| | like Morning - 0, Noon - 1, Evening - 2 etc. |
| Combined Input to Model | Above input features are normalized first |
| | and then concatenated to form an input |
| | vector |
| Training Label | A binary value either 1 or 0 representing the |
| | conversation event or not |

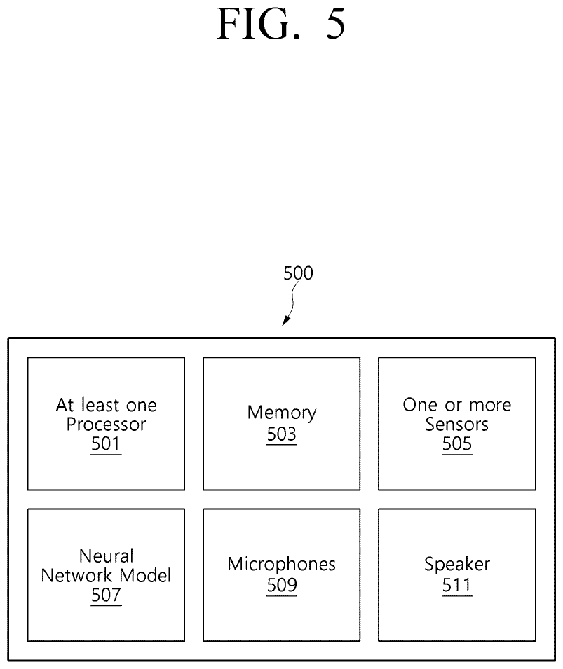

FIG. 5 illustrates a block diagram of a system for conversation detection in earphones, in accordance with an embodiment of the present disclosure. In one embodiment, the system 500 may be similar to the system 105 of FIG. 1.

In an embodiment of the present disclosure, the system 500 may comprise a memory 503, at least one processor 501, one or more sensors 505, microphones 509, a neural network model 507, and a speaker 511 communicatively coupled with each other. In one non-limiting embodiment, the system 500 may also comprise an input unit, output module, and communication interface. In one embodiment, the system 500 may be earphones. In another embodiment, the system 500 may be a part of the earphones.

It may be noted that, in some embodiments, the system 500 may include more or fewer components than those depicted herein. The various components of the system 500 may be implemented using hardware, software, firmware or any combinations thereof. Further, the various components of the system 500 may be operably coupled with each other. More specifically, various components of the system 500 may be capable of communicating with each other using communication channel media (such as buses, interconnects, etc.).

In one embodiment, the memory 503 is capable of storing machine executable instructions, referred to herein as instructions. In an embodiment, the at least one processor 501 is embodied as an executor of software instructions. As such, the at least one processor 501 is capable of executing the instructions stored in the memory 503 to perform one or more operations described herein.

The memory 503 can be any type of storage accessible to the at least one processor 501 to perform respective functionalities. For example, the memory 503 may include one or more volatile or non-volatile memories, or a combination thereof. For example, the memory 503 may be embodied as semiconductor memories, such as flash memory, mask ROM, PROM (programmable ROM), EPROM (erasable PROM), RAM (random access memory), etc. and the like.

In one embodiment, the at least one processor 501 may be configured to detect conversation by at least one microphone 509 of the earphones. The at least one processor 501 may be configured to detect the audio signal and may also be configured to determine that the audio signal comprises of user's voice. In an embodiment, the at least one processor 501 may be pre-trained using any voice recognition to accurately identify the user's voice in the audio signal.

Upon detecting the audio signal with the user's voice, the at least one processor 501 may be configured to compute the relatedness score of the user voice with the playback audio playing in the earphones. For this purpose, the at least one processor 501 may be configured to extract a portion of the playback audio corresponding to a predetermined time duration prior to and after a timestamp at which user's voice is detected. Then, the at least one processor 501 may be configured to computing feature vectors for each frame of the portion of the playback audio and the user voice. Thereafter, the at least one processor 501 may be configured to measure a cosine similarity between the feature vectors of the portion of the playback audio and the feature vectors of the user voice.

In the case where the user is humming or singing the same song as the playback audio, the cosine similarity between the feature vectors of the playback audio and the feature vectors of the user's voice will be high. Thereafter, the at least one processor 501 is configured to calculate the relatedness score based on the measured cosine similarity.

Further, the at least one processor 501 may be configured to determine the intelligibility score of the user voice for a predetermined distance. For this purpose, the at least one processor 501 may be configured to add attenuation to the user voice for the predetermined distance. The amount of attenuation added to the user voice is based on the predetermined distance. Then, the at least one processor 501 may be configured to generate a modified voice signal by adding an ambient noise signal to the attenuated user voice. The ambient noise signal comprises an environmental noise present in the surrounding of the user. Thereafter, the at least one processor 501 may be configured to perform an audio speech recognition on the user voice and the modified voice signal.

The at least one processor 501 may also be configured to determine a word recognition rate of the modified voice signal based on the user voice and the modified signal. The at least one processor 501 may be then configured to compute the intelligibility score based on the word recognition rate. In a case where the word recognition rate is equal to higher than the pre-determined threshold, the at least one processor 501 may be configured to compute the intelligibility score to have a high value. On the other hand, if the word recognition rate is low, the at least one processor 501 may be configured to compute a low intelligibility score.

Furthermore, the at least one processor 501 may be configured to determine a situation context of the user. The situation context of the user comprises at least one of ambient noise level, activity state of the user, nearby unique voices, a location of the user, and a time of day.

In order to determine the ambient noise level, the at least one processor 501 may be configured to determine the decibel level of the user voice. The at least one processor 501 may be configured to determine the decibel level of the ambient noise signal. The at least one processor 501 may be configured to determine the ambient noise level based on the decibel level of the user voice and the decibel level of the ambient noise signal.

In an embodiment, the at least one processor 501 may be configured to determine a high ambient noise level in the case where the decibel level of the ambient noise signal is higher than the user voice signal. On the other hand, the at least one processor 501 may determine a low ambient noise level in the case where the decibel level of the ambient noise signal is lower than the user voice signal.

Further, to determine the situation context of the user, the at least one processor 501 may also be configured to determine the activity state of the user. The at least one processor 501 may be configured to determine the activity state of the user based on the sensor data captured by one or more sensors 505. The one or more sensors 505 may at least comprise an accelerator and a gyroscope. However, the one or more sensors 505 are not limited to above example and any other sensors that may be used for determining user activity and known to a person skilled in the art is well with the scope of the present disclosure.

Furthermore, to determine the situation context of the user, the at least one processor 501 may also be configured to determine the nearby unique voices. In order to determine one or more unique voices, the at least one processor 501 may be configured to retrieve one or more audio samples of a predetermined time period from the detected audio signal. Thereafter, the at least one processor 501 may be configured to apply speech diarization technique on the one or more audio samples to identify one or more unique voices in the audio samples. The technique to determine one or more unique voices in the audio signal, is discussed in detail in the embodiments above. Further, the at least one processor 501 may be configured to receive a location of the user, and a time of day from the smartphone connected to the system 500.

The at least one processor 501 may be configured to determine the direction of one or more unique voices identified in the audio samples. For this purpose, the at least one processor 501 may be configured to identify a difference in timestamps of voice of a same speaker in a microphone of a left earphone and in a microphone of a right earphone for each unique voice. Thereafter, the at least one processor 501 may be configured to identify a difference in decibel levels of voice of same speaker in the microphone of the left earphone and in the microphone of the right earphone; and determine whether position of the speaker of each unique voice is on a right side or a left side of the user at least based on the difference in the timestamps and difference in decibel levels.

Further, the at least one processor 501 may be configured to compute a directional probability of conversation. The at least one processor 501 may be configured to receive inertial measurement unit (IMU) data captured by one or more sensors 505. In one embodiment, the one or more sensors may be installed in the earphones and may provide the captured IMU data to the system 105. Further, the at least one processor 501 may be configured to filter noise from the IMU data by applying high/low pass filter to the IMU data. Lastly, the system 105 may determine head tracking information by applying a sensor fusion technique to the filtered IMU data. Further, the at least one processor 501 may determine a direction of the user's head based on the head tracking information, Lastly, the at least one processor 501 may be configured to match the direction of the user's head with the direction of each unique voice to determine the directional probability of conversation.

Lastly, the at least one processor 501 may be configured to determine a conversational probability. The neural network model 507 may be configured to receive the relatedness score, the intelligibility score, the situation context, and the directional probability as input for processing.

The neural network model 507 provides a conversation probability based on the relatedness score and the intelligibility score. In another embodiment, the neural network model 507 may be configured to provide a conversation probability based on the intelligibility score, the situation context and the directional probability of conversation. The neural network model 507 computes a conversation probability score as discussed in the above embodiments.

In one non-limiting embodiment, the at least one processor 501 may be configured to train the neural network model 507 based on a sample set of parameters including relatedness scores, intelligibility scores, situation context, and directional probability for estimating of the conversation probability. In an embodiment, the neural network model 507 may be trained one-time before deployment.

Accordingly, the at least one processor 501 may be configured to adjust the volume of the playback audio based on the conversation probability and restore the volume of the playback audio in the earphones in response to determination of an end of the conversation.

The at least one processor 501 may be configured to reduce the volume of the playback audio in the speaker 511, if the conversation probability is greater than a predetermined threshold. Moreover, once the at least one processor 501 is configured to detect the start of a conversation if the conversation probability is greater than a predetermined threshold. The at least one processor 501 defines a timestamp for the start of the conversation.

Thereafter, the at least one processor 501 determines an initial direction of the user's head at the timestamp of start of the conversation based on inertial measurement unit (IMU) data captured by one or more sensors 505. The at least one processor 501 may be configured to determine an end of the conversation if the following two conditions are met. Firstly, a current direction of the user's head is different from the initial direction of the user's head at the start of the conversation and the user voice or unique voice is absent for a first predetermined time duration. Furthermore, the user voice or unique voice is observed to be absent for a second predetermined time duration. The second predetermined time duration must be greater than the first predetermined time duration.

Thereafter, upon determining that the end of the conversation, the at least one processor 501 may be configured to restore the volume of the playback audio in the earphones.

Thus, the system 500 of the present disclosure enhances the conversation awareness feature in earphones by ensuring accurate activation in various environments and preventing unintended activation during user activities like humming or singing, thereby improving the overall user experience.

The at least one processor 501 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning may refer to, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

In one or more examples, the learning algorithm may be a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

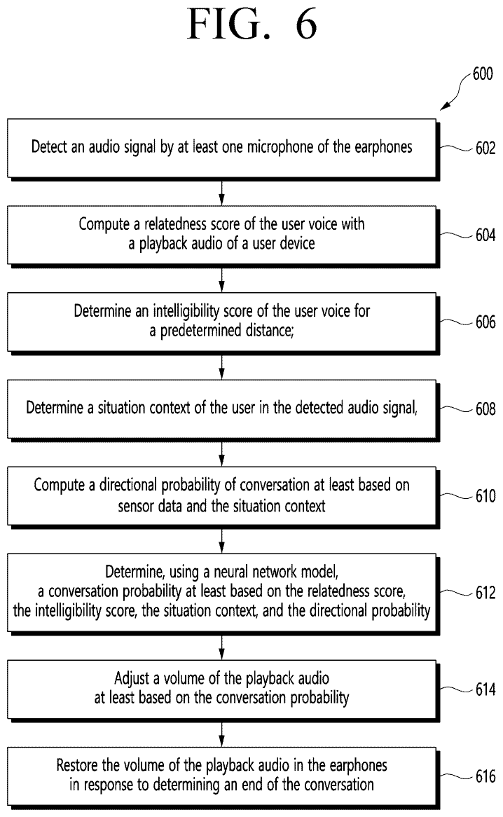

FIG. 6 illustrates a flowchart for a method for conversation detection in earphones, in accordance with an embodiment of the present disclosure. In one or more examples, the process illustrated in the flowchart of FIG. 6 may be implemented by the at least one processor 501 (FIG. 5).

At step 602, the method 600 discloses detecting an audio signal by the at least one microphone of the earphones. Furthermore, the method also comprises determining if the audio signal comprises the user voice. In an embodiment, the system on which the method 600 is implemented may be pre-trained to determine identify the user's voice from an audio signal.

At step 604, the method 600 discloses computing a relatedness score of the user voice with a playback audio of a user device. The method 600 comprises extracting a portion of the playback audio corresponding to a predetermined time duration prior to and after a timestamp at which user voice is detected. Thereafter, the method 600 also discloses computing feature vectors for each frame of the portion of the playback audio and the user voice. The method 600 also comprises measuring a cosine similarity between the feature vectors of the portion of the playback audio and the feature vectors of the user voice and calculating the relatedness score based on the measured cosine similarity.

At step 606, the method 600 discloses determining an intelligibility score of the user voice for a predetermined distance. The method 600 comprises adding attenuation to the user voice for the predetermined distance and generating a modified voice signal by adding an ambient noise signal to the attenuated user voice. The method 600 further comprises performing an audio speech recognition on the user voice and the modified voice signal. Thereafter, the method 600 discloses determining a word recognition rate of the modified voice signal based on the user voice and the modified signal; and computing the intelligibility score based on the word recognition rate.

At step 608, the method 600 discloses determining a situation context of the user in the detected audio signal. The situation context comprises at least one of ambient noise level, activity state of the user, nearby unique voices, a location of the user, and a time of day. The situation context may be determined using the procedure as discussed in above embodiments.

At step 610, the method 600 discloses computing a directional probability of conversation at least based on sensor data and the situation context. For determining the directional probability of conversation, the method 600 comprises receiving inertial measurement unit (IMU) data captured by one or more sensors, filtering noise from the IMU data by applying high/low pass filter to the IMU data, determining head tracking information by applying a sensor fusion technique to the filtered IMU data, determining a direction of the user's head based on the head tracking information, and matching the direction of the user's head with the direction each unique voice to determine the directional probability of conversation.

At step 612, the method 600 discloses determining, using a neural network model, a conversation probability at least based on the relatedness score, the intelligibility score, the situation context, and the directional probability.

At step 614, the method 600 discloses adjusting a volume of the playback audio at least based on the conversation probability. In the case where the conversation probability is high, the method 600 discloses reducing the playback audio volume if the conversation probability is greater than a predetermined threshold.

At step 616, the method 600 discloses restoring the volume of the playback audio in the earphones in response to determining the end of the conversation. For determining the end of the conversation, the method 600 discloses detecting a start of the conversation if the conversation probability is greater than a predetermined threshold and defining a timestamp for the start of the conversation, determining an initial direction of the user's head at the timestamp of start of the conversation at least based on inertial measurement unit (IMU) data captured by one or more sensors. The, the method 600 discloses determining an end of the conversation has ended if: a current direction of the user's head is different from the initial direction of the user's head at the start of the conversation and absence of user voice/unique voice is observed for a first predetermined time duration, or absence of user voice/unique voice is observed for a second predetermined time duration, wherein the second predetermined time duration is greater than the first predetermined time duration.

Thus, the method 600 enhances the conversation awareness feature in earphones by ensuring accurate activation in various environments and preventing unintended activation during user activities like humming or singing, thereby improving the overall user experience.

The sequence of operations of the method 600 need not be necessarily executed in the same order as they are presented. Further, one or more operations may be grouped together and performed in form of a single step, or one operation may have several sub-steps that may be performed in parallel or in sequential manner.

The disclosed method with reference to FIG. 6, or one or more operations of the system 500 explained with reference to FIG. 6 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” may be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

What is claimed is:

1. A method for conversation detection in earphones, the method comprising:
detecting an audio signal by at least one microphone of the earphones, wherein the detected audio signal comprises a user voice of a user of the earphones;
determining a relatedness score of the user voice with a playback audio of a user device;
determining an intelligibility score of the user voice for a predetermined distance;
determining a situation context of the user of the earphones in the detected audio signal, wherein the situation context comprises at least one of an ambient noise level, an activity state of the user of the earphones, one or more unique voices different from the user voice, a location of the user of the earphones, and a time of day;
determining a directional probability of a conversation based on at least sensor data and the situation context;
determining, using a neural network model, a conversation probability based on at least the relatedness score, the intelligibility score, the situation context, and the directional probability, the conversation probability indicating a probability that the conversation has started;
adjusting a volume of the playback audio based on at least the conversation probability; and
restoring the volume of the playback audio in the earphones based on determining an end of the conversation.

2. The method as claimed in claim 1, wherein the determining the relatedness score comprises:
extracting a portion of the playback audio corresponding to a predetermined time duration prior to and after a timestamp at which the user voice is detected;
determining one or more feature vectors for each frame of the portion of the playback audio and the user voice;
measuring a cosine similarity between the one or more feature vectors of the portion of the playback audio and the one or more feature vectors of the user voice; and
determining the relatedness score based on the measured cosine similarity.

3. The method as claimed in claim 1, wherein the determining the intelligibility score of the user voice for the predetermined distance comprises:
adding attenuation to the user voice for the predetermined distance to generate an attenuated user voice, wherein an amount of the attenuation is based on the predetermined distance;
generating a modified voice signal by adding an ambient noise signal to the attenuated user voice, wherein the ambient noise signal comprises an environmental noise present in a surrounding of the user;
performing an audio speech recognition on the user voice and the modified voice signal;
determining a word recognition rate of the modified voice signal based on the user voice and the modified voice signal; and
determining the intelligibility score based on the word recognition rate.

4. The method as claimed in claim 3, further comprising:
determining a decibel level of the user voice;
determining a decibel level of the ambient noise signal; and
determining the ambient noise level based on the decibel level of the user voice and the decibel level of the ambient noise signal.

5. The method as claimed in claim 1, further comprising:
determining the activity state of the user based on the sensor data obtained by one or more sensors, wherein the one or more sensors comprises an accelerator and a gyroscope.

6. The method as claimed in claim 1, further comprising:
retrieving one or more audio samples of a predetermined time period from the detected audio signal; and
applying a speech diarization technique on the one or more audio samples to identify the one or more unique voices different from the user voice in the one or more audio samples.

7. The method as claimed in claim 6, further comprising:
determining a direction of the one or more unique voices different from the user voice identified in the one or more audio samples by performing for each unique voice:
identifying a difference in timestamps of a voice of a same speaker in a first microphone of a left earphone of the earphones and in a second microphone of a right earphone of the earphones;
identifying a difference in decibel levels of the voice of the same speaker in the first microphone of the left earphone and in the second microphone of the right earphone; and
determining whether a position of the speaker of each unique voice is on a right side or a left side of the user based on at least the difference in the timestamps and the difference in the decibel levels.

8. The method as claimed in claimed 1, wherein the determining the directional probability of the conversation comprises:
receiving inertial measurement unit (IMU) data obtained by one or more sensors of the earphones;
filtering noise from the IMU data by applying a high pass or a low pass filter to the IMU data;
determining head tracking information by applying a sensor fusion technique to the filtered IMU data;
determining a direction of a head of the user of the earphones based on the head tracking information; and
matching the direction of the head of the user of the earphones with a direction of each unique voice to determine the directional probability of the conversation.

9. The method as claimed in claim 1, further comprising:
training the neural network model based on a sample set of parameters including relatedness scores, intelligibility scores, situation context, and directional probability for estimating of the conversation probability, wherein each parameter is assigned a corresponding weight.

10. The method as claimed in claim 1, wherein the adjusting the volume of the playback audio further comprises:
reducing the volume of the playback audio based on the conversation probability being greater than a predetermined threshold.

11. The method as claimed in claim 1, wherein the determining the end of the conversation further comprises:
detecting the conversation has started based on the conversation probability being greater than a predetermined threshold and defining a timestamp for a start of the conversation;
determining an initial direction of a head of the user of the earphones at the timestamp of the start of the conversation at least based on inertial measurement unit (IMU) data obtained by one or more sensors of the earphones; and
determining the conversation has ended based on:
a current direction of the head of the user of the earphones being different from the initial direction of the head of the user of the earphones at the start of the conversation and an absence of the user voice or an absence of the one or more unique voices being observed for a first predetermined time duration, or
the absence of the user voice the absence of the one or more unique voices being observed for a second predetermined time duration, wherein the second predetermined time duration is greater than the first predetermined time duration.

12. A system for conversation detection in earphones, the system comprising:
a memory storing one or more instructions;
one or more sensors;
a neural network model;
at least one processor operatively coupled to the memory, the one or more sensors, and the neural network model,
wherein the one or more instructions, when executed by the at least one processor individually or collectively, cause the system to:
detect an audio signal by at least one microphone of the earphones, wherein the detected audio signal comprises a user voice of a user of the earphones,
determine a relatedness score of the user voice with a playback audio of a user device,
determine an intelligibility score of the user voice for a predetermined distance,
determine a situation context of the user of the earphones in the detected audio signal, wherein the situation context comprises at least one of an ambient noise level, an activity state of the user of the earphones, one or more unique voices different from the user voice, a location of the user of the earphones, and a time of day,
determine a directional probability of a conversation based on at least sensor data and the situation context,
determine, using the neural network model, a conversation probability based on at least the relatedness score, the intelligibility score, the situation context, and the directional probability, the conversation probability indicating a probability that the conversation has started,
adjust a volume of the playback audio based on at least the conversation probability, and
restore the volume of the playback audio in the earphones based on determination of an end of the conversation.

13. The system as claimed in claim 12, wherein to determine the relatedness score, the one or more instructions, when executed by the at least one processor individually or collectively, cause the system to:
extract a portion of the playback audio corresponding to a predetermined time duration prior to and after a timestamp at which the user voice is detected,
determine one or more feature vectors for each frame of the portion of the playback audio and the user voice,
measure a cosine similarity between the one or more feature vectors of the portion of the playback audio and the one or more feature vectors of the user voice, and
determine the relatedness score based on the measured cosine similarity.

14. The system as claimed in claim 12, wherein to determine the intelligibility score of the user voice for the predetermined distance, the one or more instructions, when executed by the at least one processor individually or collectively, cause the system to:
add attenuation to the user voice for the predetermined distance to generate an attenuated user voice, wherein an amount of the attenuation is based on the predetermined distance,
generate a modified voice signal by adding an ambient noise signal to the attenuated user voice, wherein the ambient noise signal comprises an environmental noise present in a surrounding of the user,
perform an audio speech recognition on the user voice and the modified voice signal,
determine a word recognition rate of the modified voice signal based on the user voice and the modified voice signal, and
determine the intelligibility score based on the word recognition rate.

15. The system as claimed in claim 14, wherein the one or more instructions, when executed by the at least one processor individually or collectively, cause the system to:
determine a decibel level of the user voice,
determine a decibel level of the ambient noise signal, and
determine the ambient noise level based on the decibel level of the user voice and the decibel level of the ambient noise signal.

16. A non-transitory computer readable medium having instructions stored therein, which when executed by a processor cause the processor to execute a method for conversation detection in earphones, the method comprising:
detecting an audio signal by at least one microphone of the earphones, wherein the detected audio signal comprises a user voice of a user of the earphones;
determining a relatedness score of the user voice with a playback audio of a user device;
determining an intelligibility score of the user voice for a predetermined distance;
determining a situation context of the user of the earphones in the detected audio signal, wherein the situation context comprises at least one of an ambient noise level, activity state of the user of the earphones, one or more unique voices different from the user voice, a location of the user of the earphones, and a time of day;
determining a directional probability of a conversation based on at least sensor data and the situation context;
determining, using a neural network model, a conversation probability based on at least the relatedness score, the intelligibility score, the situation context, and the directional probability, the conversation probability indicating a probability that the conversation has started;
adjusting a volume of the playback audio based on at least the conversation probability; and
restoring the volume of the playback audio in the earphones based on determining an end of the conversation.

17. The non-transitory computer readable medium according to claim 16, wherein the determining the relatedness score comprises:
extracting a portion of the playback audio corresponding to a predetermined time duration prior to and after a timestamp at which the user voice is detected;
computing one or more feature vectors for each frame of the portion of the playback audio and the user voice;
measuring a cosine similarity between the one or more feature vectors of the portion of the playback audio and the one or more feature vectors of the user voice; and
determining the relatedness score based on the measured cosine similarity.

18. The non-transitory computer readable medium according to claim 16, wherein the determining the intelligibility score of the user voice for the predetermined distance comprises:
adding attenuation to the user voice for the predetermined distance to generate an attenuated user voice, wherein an amount of the attenuation is based on the predetermined distance;
generating a modified voice signal by adding an ambient noise signal to the attenuated user voice, wherein the ambient noise signal comprises an environmental noise present in a surrounding of the user;
performing an audio speech recognition on the user voice and the modified voice signal;
determining a word recognition rate of the modified voice signal based on the user voice and the modified voice signal; and
determining the intelligibility score based on the word recognition rate.

19. The non-transitory computer readable medium according to claim 18, further comprising:
determining a decibel level of the user voice;
determining a decibel level of the ambient noise signal; and
determining the ambient noise level based on the decibel level of the user voice and the decibel level of the ambient noise signal.

20. The non-transitory computer readable medium according to claim 16, further comprising:
determining the activity state of the user based on the sensor data obtained by one or more sensors, wherein the one or more sensors comprises an accelerator and a gyroscope.
